(19) United States
(12) Patent Application Publication
(10) Pub. No.: US 2007/0293267 A1
(43) Pub. Date: Dec. 20, 2007

(54) Multi-function wireless transmission device

(76) Inventor: Yung-Sheng Chang, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/455,767

(22) Filed: Jun. 20, 2006

(51) Int. Cl. H04B 1/38

(52) U.S. Cl. 455/558

(57) ABSTRACT

A multi-function wireless transmission device has a casing, a circuit board assembled inside said casing, and at least two connectors electrically connecting with said circuit board. The circuit board includes a wireless transmission chip and circuits for the read-write of media storage devices, i.e. flash cards, the circuits connecting with the wireless transmission chip. There are at least two connectors including a USB connector for insertion to a USB port of a computer host, and a one-to-one or one-to-many memory card connector type for the data communication with memory cards. The multi-function wireless transmission device provides communication over high-frequency wireless, and communication interconnection of access to memory cards, data transmission, and voice transmission.

### BACKGROUND OF THE INVENTION

1. Field of the Invention

The present invention relates to a multi-function wireless transmission device, and particularly to a multi-function wireless transmission device which combines the function of data/voice/media exchange between a computer and other wireless enabled devices and the function of multiple media data read and write. The multi-function wireless transmission device connects with a computer via Universal Serial Bus (USB) connection to transmit data, voice

2. Related Art

Peripheral devices are generally connected by a computer host with cables for data transmission therebetween in earlier time. Many peripherals are needed for different tasks and functions, which results in a lot of cables and very complicated wiring near the computer. Single USB device which combines the functions of different peripheral devices is designed to solve this problem. At the same time, communication over wireless further enhances the device convenience without the consideration about physical wiring. Devices that are capable of wireless communication such as Bluetooth are able to communicate with a computer over high-frequency wireless via the multi-function wireless transmission device.

Instant data transmission promotes the development of business, and seems more expedient. Nevertheless, in prior art, wires are always required to achieve data transmission in temporal environment. Currently, memory cards or other devices with data therein are of different types and specifications, and generally communicate with a computer host simply by USB. Correspondingly, in the event that digital camera, mobile phone or memory card data access from a computer host, the complicated wiring around a computer host results from too many USB wires of each USB peripheral devices providing different functions.

### SUMMARY OF THE INVENTION

Accordingly, an object of the present invention is to provide a multi-function wireless transmission device which connects to the host computer via a USB and combines high-frequency wireless communication such as data, voice and multimedia between a host computer and wireless enabled devices, and data read-write access of various data storage media, such as memory cards.

A multi-function wireless transmission device includes a casing, a circuit board assembled inside said casing, and at least two connectors electrically connecting with said circuit board. The circuit board includes a wireless transmission chip and circuits for the read-write of media storage devices, i.e. flash cards. There are at least two connectors including a USB connector for insertion to a USB port of a computer host, and a memory card connector for communication with memory cards.

The transmission chip communicates via wireless communication technology such as Bluetooth.

The USB connector is inbuilt in the casing for, directly or indirectly, connecting with a USB port of a computer host. The USB connector is a plug-type connector, or a socket-type connector mating with a USB cable connector in use.

The memory card connector is one-for-one access type, one-for-multi access type, or combination of one-for-one access type and one-for-multi access type.

### BRIEF DESCRIPTION OF THE DRAWINGS

FIG. 1 is a perspective view of a multi-function wireless transmission device according to a first embodiment of the present invention.

FIG. 2 is a perspective view of a multi-function wireless transmission device according to a second embodiment of the present invention.

FIG. 3 is a perspective view of a multi-function wireless transmission device according to a third embodiment of the present invention.

FIG. 4 is a perspective view of a multi-function wireless transmission device according to a fourth embodiment of the present invention.

FIG. 5A and 5B respectively schematically illustrate principle of a multi-function wireless transmission device according to a first embodiment and a second embodiment of the present invention.

FIG. 6A and 6B respectively schematically illustrate principle of a multi-function wireless transmission device according to a third embodiment and a fourth embodiment of the present invention.

### DESCRIPTION OF THE PREFERRED EMBODIMENTS

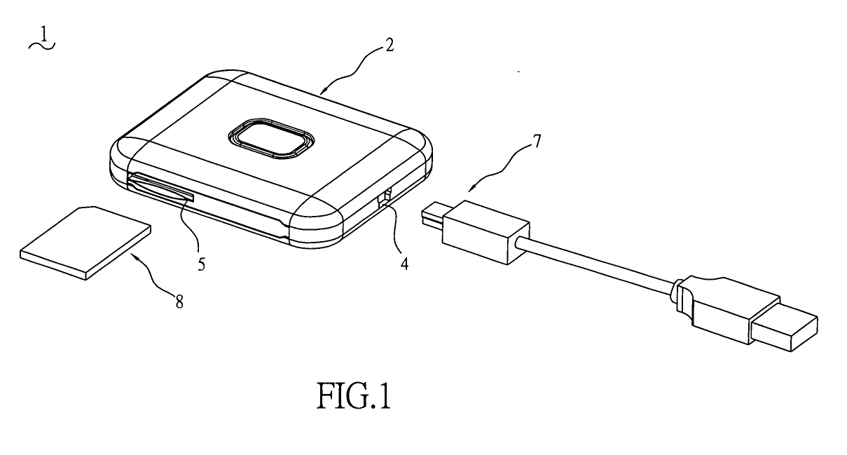

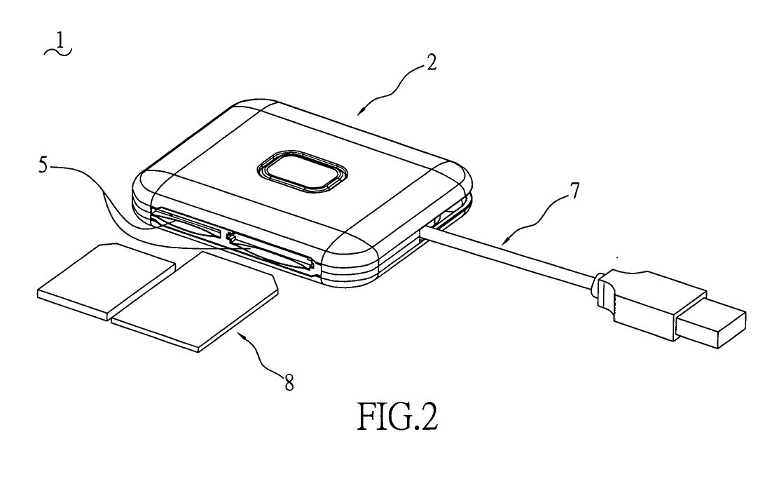

FIG. 1 shows a multi-function wireless transmission device 1 according to a first embodiment of the present invention, while FIG. 2 shows a multi-function wireless transmission device 1 according to a second embodiment of the present invention. A multi-function wireless transmission device 1 of the present invention comprises a casing 2, a circuit board 3 and at least two connectors 4, 5. The casing 2 includes two housings assembled together. The circuit board 3 is assembled inside the casing 2, and includes a transmission chip 30 and circuits (not shown) electrically connecting with the transmission chip 30. The transmission chip 30, for example, communicates at high frequency in particular area via wireless communication technology such as Bluetooth.

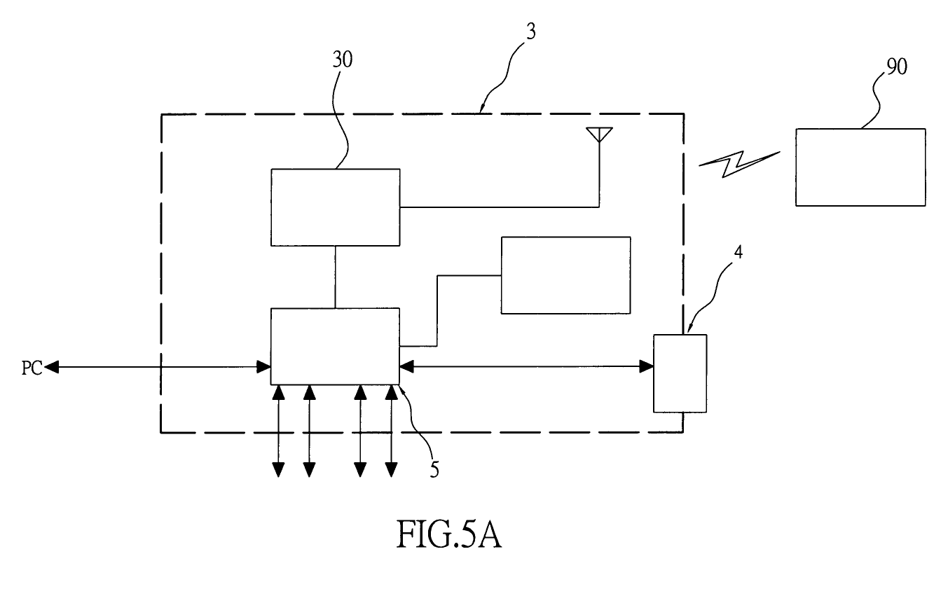

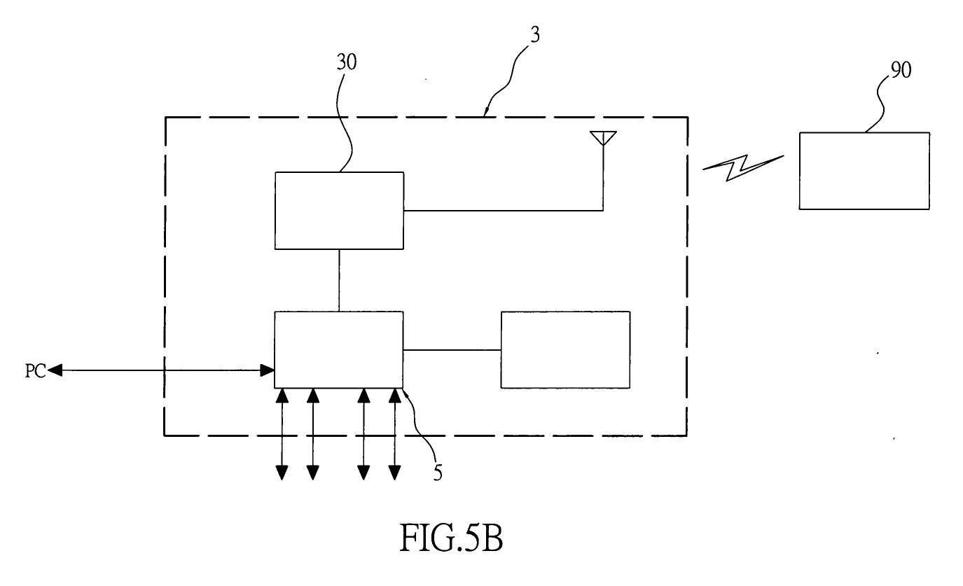

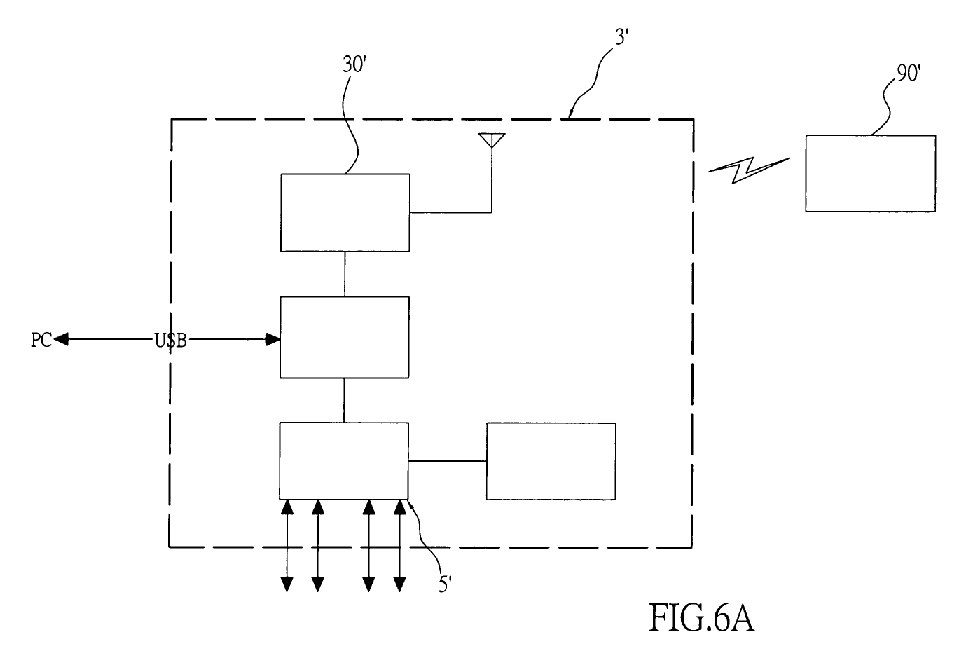

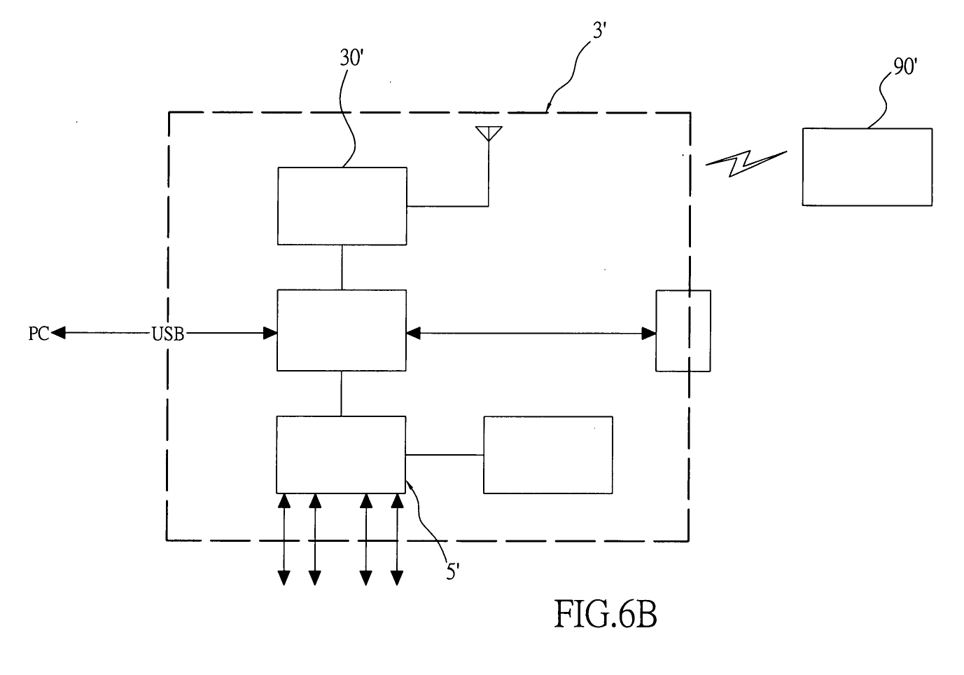

The at least two connectors 4, 5 communicate with the circuit board 3, which includes a USB connector 4 for insertion to a USB port of a computer host, and a memory card connector 5 for communication with memory cards 8. With reference to FIGS. 1 and 5A, the USB connector 4 is a socket-type connector inbuilt in the casing 2, and mates with a USB cable connector 7 in use for connection with a USB port of a computer host while various electronic products, such as Mobile phones and PDA can be interconnected via wireless communication. With reference to FIGS. 2 and 5B, a USB cable connector 7 is inbuilt in the USB connector 4 for directing to a USB port of a computer host. The memory card connector 5 has at least an insertion hole (not labeled). For example, the memory card connector 5 of the first embodiment in FIG. 1 has a single insertion hole, while the memory card connector 5 of the second embodiment in FIG. 2 has double insertion holes. Further referring to FIGS. 5A, 5B, 6A and 6B, the memory card connector 5 is one-for-one access type, one-for-multi access type, or combination of one-for-one access type and one-for-multi access type.

FIG. 5A and 5B respectively schematically illustrate communication principle of a multi-function wireless transmission device according to a first embodiment and a second embodiment of the present invention. Referring to FIGS. 5A and 5B, the transmission chip 30 of the multi-function wireless transmission device 1 communicates over high frequency wireless technology with wireless enabled products 9, for instance, a Bluetooth enable a mobile phone. The wireless transmission chip 30 is capable of wireless communication within certain distance coverage via wireless technology such as Bluetooth. The USB connector 4 provides communication connection to a USB port of a computer host, whereby wireless enabled peripheral devices communicate with the computer host for memory cards accessing, data exchange, and voice transmission.

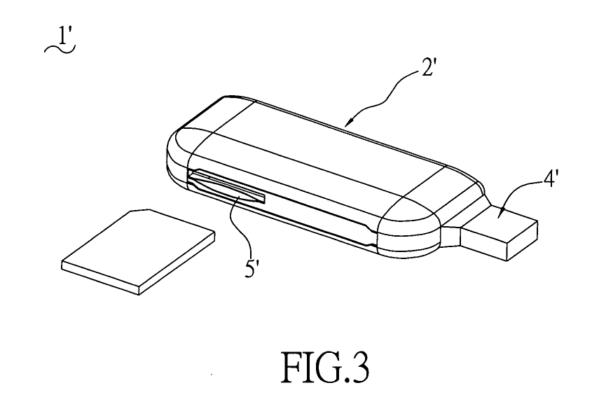

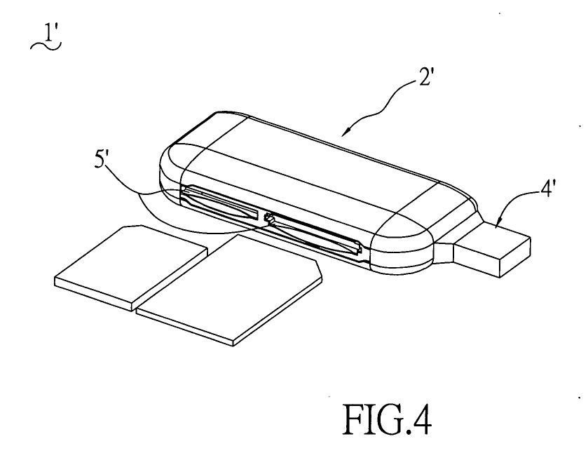

FIG. 3 illustrates a multi-function wireless transmission device 1′ according to a third embodiment of the present invention, while FIG. 4 illustrates a multi-function wireless transmission device 1′ according to a fourth embodiment of the present invention. The multi-function wireless transmission device 1′ according to the third and fourth embodiments is similar to the multi-function wireless transmission device 1 according to the first and second embodiments. The multi-function wireless transmission device 1′ of the present invention comprises a casing 2′, a circuit board 3′ and at least two connectors 4′, 5′. The USB connector 4′ is inbuilt in the casing 2′ and is plug-type. The memory card connector 5′ of the third embodiment in FIG. 3 has a single insertion hole, while the memory card connector 5′ of the fourth embodiment in FIG. 4 has double insertion holes. Referring to FIGS. 6A and 6B, the wireless transmission chip 30′ of the multi-function wireless transmission device 1′ communicate over high frequency wireless with wireless enabled products 9′, for instance, a Bluetooth enabled mobile phone. The wireless transmission chip 30′ is capable of communicating within certain distance coverage via wireless technology such as Bluetooth. The USB connector 4′ provides communication connection to a USB port of a computer host, whereby wireless enabled peripheral devices communicate with the computer host for data exchange, voice transmission and etc. Direct and indirect data access of memory cards from a host computer and wireless enabled peripheral devices can be achieved as well.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A multi-function wireless transmission device comprising:
a casing;
a circuit board assembled inside said casing, and including a wireless transmission chip and circuits for the read-write of media storage devices, the circuits connecting wireless transmission chip; and
at least two connectors connecting with said circuit board, and includes a USB connector for insertion to a USB port of a computer host, and a memory card connector for communication with memory cards.

2. The multi-function wireless transmission device as claimed in claim 1, wherein said wireless transmission chip communicates via wireless technology such as Bluetooth.

3. The multi-function wireless transmission device as claimed in claim 1, wherein said USB connector is inbuilt in said casing for, directly or indirectly, connecting with a USB port of a computer host.

4. The multi-function wireless transmission device as claimed in claim 1 or 3, wherein said USB connector is a plug-type connector, or a socket-type connector mating with a USB cable connector in use.

5. The multi-function wireless transmission device as claimed in claim 1, wherein the memory card connector is one-for-one access type, one-for-multi access type, or combination of one-for-one access type and one-for-multi access type.
